(19) United States
(12) Patent Application Publication
(10) Pub. No.: US 2009/0192637 A1
(43) Pub. Date: Jul. 30, 2009

(54) Dynamically serving altered sound content

(75) Inventors: Robert Picunko, New York, NY (US); Paul Degooyer, New York, NY (US)

Correspondence Address: PROSKAUER ROSE LLP, ONE INTERNATIONAL PLACE, BOSTON, MA, 02110, US

(73) Assignee: MTV Networks, New York, NY (US)

(21) Appl. No.: 12/271,529

(22) Filed: Nov. 14, 2008

Related U.S. Application Data
(60) Provisional application No. 60/988,243, filed on Nov. 15, 2007.

(51) Int. Cl. G06F 17/00; G06F 12/14; G06F 15/16

(52) U.S. Cl. 700/94; 726/29; 709/231

(57) ABSTRACT

In altering sound content of an audiovisual product, for example, a video game, a computer program, motion picture, television program, commercial or other like products, a server system identifies the current sound content of an audiovisual product residing in a user system, the server system determines whether the current sound content is to be altered, and the server system provides an altered sound content to the user system, if it is determined that the current sound content is to be altered. The altered sound content includes, for example a sound content that is an alternate sound content, a substitute sound content, or an updated sound content.

### CROSS REFERENCE TO RELATED APPLICATION

The present application claims benefit of U.S. Provisional Application No. 60/988,243, filed Nov. 15, 2007, the entire disclosure of which is incorporated by reference herein.

### FIELD OF THE INVENTION

The present invention relates to systems, methods, and apparatuses for dynamically providing or serving sound content to or through a video or visual display.

### BACKGROUND OF THE INVENTION

Content providers have long since included sound content into their productions in order to enhance the user experience. For example, a motion picture can include a full range of voice, music, or sound effects to match the action or mood depicted on screen. Likewise, a computer program can include music, sound effects, voice samples, and much more to inform, assist, or simply entertain the user.

The history of providing sound content into movies and television shows extends far back, with early incarnations having live music performed to accompany silent movies, then progressing to synchronized sound in movies, then progressing to remastered digital soundtracks with home-based disk players, and beyond. Likewise, software has followed a similar track, with early programs progressing from silence, to primitive utilization of one-bit internal PC speakers, to a detailed synthetic score via a dedicated sound card, to the use of a digitized score included on high-capacity digital media.

However, the current state of visual media sound content relies mainly on sound content being linked into or with the product in a static format (or with predetermined and limited choice of sound content) and included with the product sold or delivered to consumers. For example, with a television or movie product sold to a consumer in a physical form (e.g., disk, tape, etc.) or via electronic download or broadcast, the sound content that is packed in with the individual disk or tape, embedded in a download, or broadcast as part of a television or movie product remains the sole sound content accessible by the user when viewing the product. Similarly, users of software have little or no choice in the sound content selection of a particular piece of software and generally must contend with the included sound content selection, buying the software for its functional aspects and having enjoyment of the sound content as only a relatively minor factor in their buying decision process.

Therefore, from the perspective of a content provider, decisions on sound content must be finalized before each version of an audiovisual product can be distributed to consumers. This requires that all legal, financial, and artistic hurdles for a particular sound content selection are cleared in advance of sales of each product.

This arrangement also limits the potential for a content producer to extract revenue from a given product. If a product is sold to consumers with no available upgrades to features or content, then the revenue stream ends with that specific purchase.

Moreover, the growing length, complexity, and re-use of various types of entertainment products can result in diminished consumer enjoyment of the included sound content over a particularly long user experience. For a particular movie or television program that is replayed frequently (e.g., an animated childrens' movie), an end user—particularly a parent—may grow weary of a particular piece of ambient music or a particular voice of a character. Similarly, for a video game that can span 40+ hours, the user may grow tired of the included sound content that plays whenever the user engages in a common activity, such as traversing from one in-game location to another, or engaging in combat within the video game. The growing popularity of video games that focus on the music as a central play element will emphasize this trend, as the focus on the music can make a user tire of a heavily repeated song more quickly.

Some current home console video game systems give users the ability to override the supplied soundtrack to a piece of software and instead supply playlists with limited customization options for use in certain compatible software titles. However, such software played with custom playlists may lack the cohesiveness of having the sound designed by the same project team that designed the rest of the software; program designers can better anticipate more fitting sound content selections. For example, a user could have loaded a custom playlist of fast and loud music to override the in-game music in a story-driven video game, only to have a slow and poignant scene in the game unexpectedly arise and clash with the music. The in-game content thus has its value reduced by the lack of cohesion between the mood of the music playing and the mood of the story, leading to a diminished user experience. Moreover, the custom playlist may be limited to sound content that the user already owns and can provide, and which may have to be in a particular format (e.g., physical disk or particular file format, etc.), or very limited options provided by the content provider. Consequently, if a user has a limited sound content collection, the flexibility of such a system is limited. As a partial solution, some current software allows for a user to purchase a sound content add-on pack, allowing the addition to or replacement of sound content within software. This requires, however, user action for each change of sound content. Also, each new content pack must be coded by the associated programmers, leading to a relatively limited choice of new sound content.

Finally, the current state of advertising, especially in a national campaign, utilizes region-specific sound content to better cater to the customers and dealers in each specific region. However, such tailoring requires manpower to individually edit each ad for each region (e.g., country/western music in the southern U.S., Latin music in regions with a high Latino population, etc.), potentially limiting how many regions or how finely-tuned each region's sound content tailoring can be.

### SUMMARY

In view of the concerns described above, it would be useful to allow the provision of new sound content into audiovisual products while still maintaining a balance between author stylistic control and end user customization. Also, it would be useful to allow potential income from a subscription-based update service to generate new revenue streams for content producers or revenue generated by musical artists paying for their songs to be inserted into the product. Moreover, the introduction of sound content that the user may not have previously been aware of can enhance the user experience or provide a new and different user experience altogether, including by allowing multiple viewings of a product or the ability to enjoy the software or video game on multiple occasions. Finally, it would be useful to possess the ability to automatically update the sound content based on predetermined author and/or end user parameters without explicit, recurring actions from one or both parties.

A feature of an embodiment of the present invention is that updates to the sound content can be automated such that affirmative effort by the user is not required each time that the sound content is to be changed. Such automations can be on a recurring subscription basis, allowing for a recurring stream of revenue from a product, instead of making due with only revenue from the one-time product purchase.

Another feature of an embodiment of the present invention is that it can be used to facilitate a balance of user customization of sound content with artistic control of the designer by allowing users to select from a variety of parameters or categories of the sound content coded by designers, allowing for some user control of the sound content.

Another feature of an embodiment of the present invention is that product users are exposed to an increased variety of sound content beyond the default product sound content or their own personal sound content collection. Moreover, exposure to sound content beyond the default sound content results in less diminishment of user enjoyment due to tiring of the default sound content over prolonged product use.

Still another feature of an embodiment of the present invention is that content providers receive more flexibility in providing sound content to end users through their products. Because sound content can be changed after the initial shipping of a product, content providers may alter the juxtaposition of sound content with product content to provide tweaks to the existing product or to freshen the presentation of the existing product.

Yet another feature of an embodiment of the present invention is the ability to tailor the sound content of a product to a specific user-base or region.

Further features and advantages of the present invention as well as the structure and operation of various embodiments of the present invention are described in detail below with reference to the accompanying drawings.

### BRIEF DESCRIPTION OF THE DRAWINGS

FIG. 1 is a block diagram of a dynamic sound content delivery system in accordance with an example embodiment of the present invention.

FIG. 2 is an operational flow of a system for dynamically serving sound content, depicting how sound content is delivered to a user system.

FIG. 3 is an operational flow of an example embodiment of the present invention, wherein sound content is analyzed and classified.

FIG. 4 is an operational flow of an example embodiment of the present invention, wherein a choice is made from delivered sound content of a particular piece or pieces of sound content to play.

FIG. 5 is a block diagram of a computer system useful for implementing an example embodiment of the present invention.

### DETAILED DESCRIPTION

Aspects of the present invention are directed to a system, method, and computer program product for dynamically serving sound content. These aspects of the present invention are now described in more detail below in terms of an example system. This is for convenience only and is not intended to limit the application of the present invention. In fact, after reading the following description, it will be apparent to persons skilled in the relevant art how to implement the following invention in alternative embodiments.

The terms “user”, “end user”, “consumer”, “customer”, “participant”, “gamer”, “player”, “viewer”, “purchaser”, and/or the plural form of these terms are used interchangeably herein to refer to those persons or entities capable of accessing, using, being affected by, and/or benefiting from the tools that the present invention provides for dynamically inserting sound content.

The terms “audio”, “music”, “playlist”, “sound”, “soundtrack”, “chord”, “sound effect”, “song”, “sound content”, “sound recording”, and/or the plural form of these terms are used interchangeably herein to refer to a digital signal capable of interpretation and translation into an audible noise and/or music involved in the tools that the present invention provides for dynamically inserting sound content.

The terms “product”, “software”, “computer program”, “game”, “program”, “software”, “video game”, “movie”, “motion picture”, “television show”, “audiovisual work”, “visual media work”, “advertisement”, and/or the plural form of these terms are used interchangeably herein to refer to a user-executable or otherwise user-playable audiovisual product that incorporates sound content in the tools that the present invention provides for dynamically inserting sound content.

The terms “producer”, “programmer”, “artist”, “content provider”, “distributor”, and/or the plural form of these terms are used interchangeably herein to refer to those persons or entities capable of accessing, using, being affected by, and/or benefiting from the tools that the present invention provides for dynamically inserting sound content.

The term “altered sound content” is used herein to refer to a sound content that is an alternate sound content, a substitute sound content, an updated sound content or any other sound content in general that is going to be used to replace the current sound content.

The term “dynamically served” is used herein to refer to the activity of providing sound content to a product while the product is being enjoyed by the user. The sound content may come from a variety of locations, including but not limited to a file stored on a local storage medium, a file obtained over a real-time network stream, broadcast service, over the air or otherwise.

According to an aspect of the invention, a method is provided for altering sound content of a visual media work. The method includes a server system identifying current sound content of a visual media work residing in a user system. The method also includes the server system determining whether the current sound content is to be altered, and if so, providing an altered sound content to the user system, whether provided in synchronization to aspects of the visual media work or as ambient sound or otherwise. As described herein, altering the sound content includes, for example, replacing the current sound content with an alternative sound content.

Further, the method may include the server system determining that the current sound content is to be altered based on a date associated with the current sound content or product, or a type of the current sound content or product.

Also, the method may include the server system receiving, from the user system, a user preference for sound content (including a type or genre of sound content or particular songs), wherein the server system determines whether the current sound content is to be altered based on a comparison of the current sound content and the user preference for such sound content or songs.

Moreover, the method may include the server system accessing subscription information stored in a memory, wherein the server system provides the altered sound content to the user system if the user system is listed in the subscription information accessed from the memory.

Similarly, the method may include the server system accessing a memory storing sound content to obtain the altered sound content.

The method may also include the server system providing the altered sound content in real time during execution or viewing of the audiovisual work or computer program.

Also, the visual media work may be a video game. The altered sound content provided to the user system may include sound units that correspond to situations taking place when the video game is played, with those situations including: fast, slow, happy, angry, nervous, calm, sad, tired, scared, and aggressive.

Likewise, the visual media work may be a motion picture. The altered sound content provided to the user system may include sound units that correspond to situations taking place when the motion picture is viewed, with those situations including: fast, slow, happy, angry, nervous, calm, sad, tired, scared, and aggressive.

Also, the visual media work may be a television program or commercial. The altered sound content provided to the user system may include sound units that correspond to situations taking place when the television program or commercial is played, with those situations including: fast, slow, happy, angry, nervous, calm, sad, tired, scared, and aggressive.

According to an aspect of the method, the altered sound content may be characterized by at least one of: jazz, hip-hop, classic rock, hard rock, punk, folk, blues, funk, classical, opera, x-rated, child-friendly, or other genres.

According to another aspect of the current invention, a system is provided for altering sound content of a visual media work residing in a user system connected to a network. The system has a processor and is programmed with modules. These modules can identify a current sound content of the visual media work residing in the user system, determine whether the current sound content is to be altered, and provide an altered sound content to the user system, if it is determined that the current sound content is to be altered.

Also, the system may determine that the current sound content is to be altered based on a date associated with the current sound content or product, or a type of the current sound content or product.

Further, the processor may be programmed with a module to receive, from the user system, a user preference for sound content, and the system may determine whether the current sound content is to be altered based on a comparison of the current sound content and the user preference for sound content.

Moreover, the processor may be programmed with a module to access subscription information stored in a memory, and the system may provide the altered sound content to the user system if the user system is listed in the subscription information accessed from the memory.

Similarly, the processor may be programmed with a module to access a memory storing sound content to obtain the altered sound content, and the altered sound content may be provided in real time during execution of the audiovisual work, video game, computer program, or software.

Further, the visual media work may be a video game, with the altered sound content provided to the user system including sound units that correspond to situations taking place when the video game is played, which may include: fast, slow, happy, angry, nervous, calm, sad, tired, scared, and aggressive.

Likewise, the visual media work may be a motion picture, with the altered sound content provided to the user system including sound units that correspond to situations taking place when the motion picture is viewed, which may include: fast, slow, happy, angry, nervous, calm, sad, tired, scared, and aggressive.

Similarly, the visual media work may be a television program or commercial, with the altered sound content provided to the user system including sound units that correspond to situations taking place when the television program or commercial is viewed, which may include: fast, slow, happy, angry, nervous, calm, sad, tired, scared, and aggressive.

Also, the altered sound content may be characterized by at least one of: jazz, hip-hop, classic rock, hard rock, punk, folk, blues, funk, classical, opera, x-rated, child-friendly, or other genre.

According to yet another aspect of the current invention, a computer-readable storage medium is provided for storing a program that when executed by a computer causes the computer to implement a method of altering sound content of a user visual media work, wherein the method includes identifying a current sound content of a visual media work residing in a user system, determining whether the current sound content is to be altered, and providing an altered sound content to the user system if it is determined that the current sound content is to be altered.

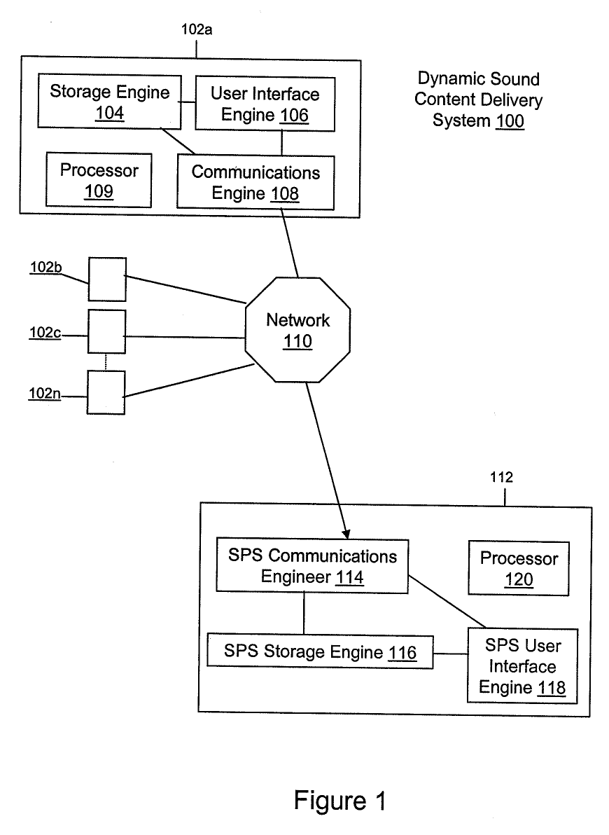

FIG. 1 is a block diagram of a dynamic sound content delivery system 100 in accordance with an example embodiment of the present invention.

User system 102a is the hardware that runs the product with the user-selectable sound content. Example user systems take on many forms, including but not limited to a personal computer, a standalone video player, a home video game console, a portable video game system, a personal digital assistant (PDA), an internet appliance, a smart phone, or the like. User systems 102b-102n are conceptually similar to the user system 102a; although they can take the form of alternate hardware, software, or organization of components, they can interact concurrently with other parts of the system 100. The user system 102a includes storage engine 104, user interface engine 106, communications engine 108, and processor 109.

The storage engine 104 stores, reads, and searches data that is provided to it by the communications engine 108. The storage engine 104 contains at least temporarily a plurality of sound content delivered to the user system 102a (and as discussed in more detail below) and may, in some implementations, contain some or all of the code of a product for which the plurality of sound content is delivered. The storage engine 104 can be readily implemented by one skilled in the art, and may consist of any or a combination of devices such as a hard drive, a volatile memory, a tape drive, a floppy drive, a USB memory key, a removable flash-based memory, a built-in flash-based memory, etc., as well as the software and hardware needed to provide read, write, and search functionality to these example implementations.

The user interface engine 106 allows a user to interact with the various aspects of the user system 102a, such as the computer program, audiovisual work, or the user-alterable sound content classifications (discussed below in connection with Block 404), among others. The user interface engine 106 can be readily implemented by one skilled in the art, and may consist of such implementations as a combination of any or all of the following: an audio speaker system, a television, a computer monitor, a projector, a mouse, a keyboard, a joystick, an analog controller, a digital controller, a microphone, a touch-sensitive LCD screen, a disk drive, a USB memory key, a digital camera, a motion sensor, an accelerometer, a heat sensor, an infrared remote control, an Ethernet-based network connection, an 802.11 type or other wifi connection, or the like, as well as any hardware or software used to implement any of the above.

The communications engine 108 sends and receives data to and from service provider system 112 through network 110. The communications engine 108 may utilize any communications technologies known to a practitioner of the art, including but not limited to traditional Ethernet cards, telephone line modems, 802.11 type or other wifi connections, and the like. Furthermore, the communications engine 108 may share some or all of the physical components utilized in the user interface engine 106.

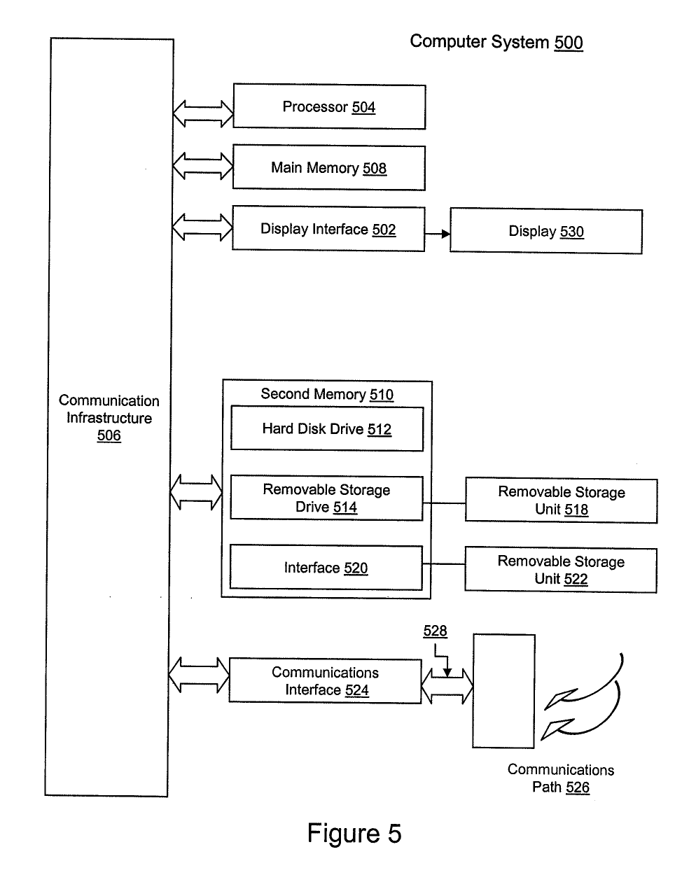

The processor 109 performs the operations required by the storage engine 104, the user interface engine 106, and the communications engine 108 in a manner known to a practitioner of the art. See FIG. 5 its and related discussion for a more detailed explanation.

The network 110 channels communications from the user system 110 to the service provider system 112. The network 110 may be a private network, such as a LAN, or a remote network, such as the Internet or the World Wide Web.

The service provider system (SPS) 112 provides input, storage, and delivery of sound content to the user systems 102a-n. The SPS 112 includes SPS communications engine 114, SPS storage engine 116, SPS user interface engine 118, and processor 120.

The SPS communications engine 114 sends and receives data to and from the user system 102a through the network 110. The SPS communications engine 114 may utilize any communications technologies known to a person skilled in the art, including but not limited to traditional Ethernet cards, telephone-based modems, 802.11a/b/g/n wifi connections, and the like. Although the SPS communications engine 114 is conceptually similar to the communications engine 108, it may or may not be implemented using similar hardware.

The SPS storage engine 116 stores, reads, and searches data therein. The SPS storage engine 116 contains, at least temporarily, the plurality of sound content for delivery to the plurality of user systems 102a-n (and as discussed in more detail below). The SPS storage engine 116 can be readily implemented by one skilled in the art, and may consist of any or a combination of devices such as a hard drive, a volatile memory, a tape drive, a floppy drive, a USB memory key, a removable flash-based memory, a built-in flash-based memory, etc., as well as the software and hardware needed to provide read, write, and search functionality to these example implementations.

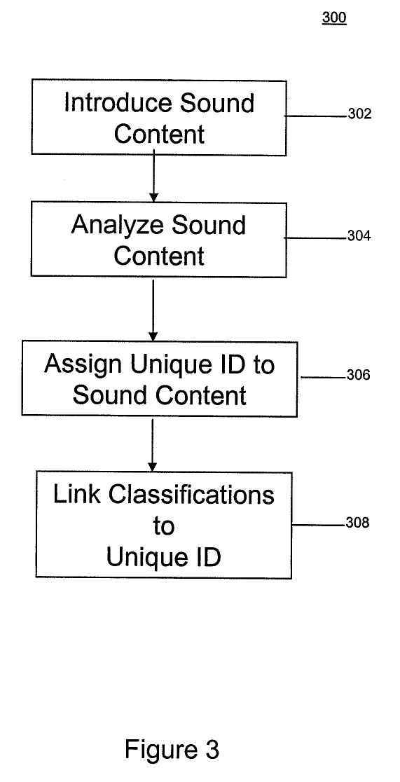

The SPS user interface engine 118 allows a user to interact with the various aspects of the SPS 112, including but not limited to loading sound content into the system and classifying the sound content as discussed below in connection with FIG. 3. The SPS user interface engine 118 can be readily implemented by one skilled in the art, and may consist of such implementations as a combination of any or all of the following: an audio speaker system, video game console, computer, a television, a computer monitor, a projector, mobile phone screen, a mouse, a keyboard, a joystick, an analog controller, a handheld device, a digital controller, a microphone, a touch-sensitive LCD screen, a disk drive, a USB memory key, a digital camera, a motion sensor, an accelerometer, a heat sensor, an infrared remote control, an Ethernet-based network connection, an 802.11 type or other wifi connection, or the like, as well as any hardware or software required to implement any of the above.

The processor 120 performs the operations required by the SPS storage engine 116, the SPS user interface engine 118, and the SPS communications engine 114 in a manner known to a practitioner of the art. See FIG. 5 and related discussion for a more detailed explanation.

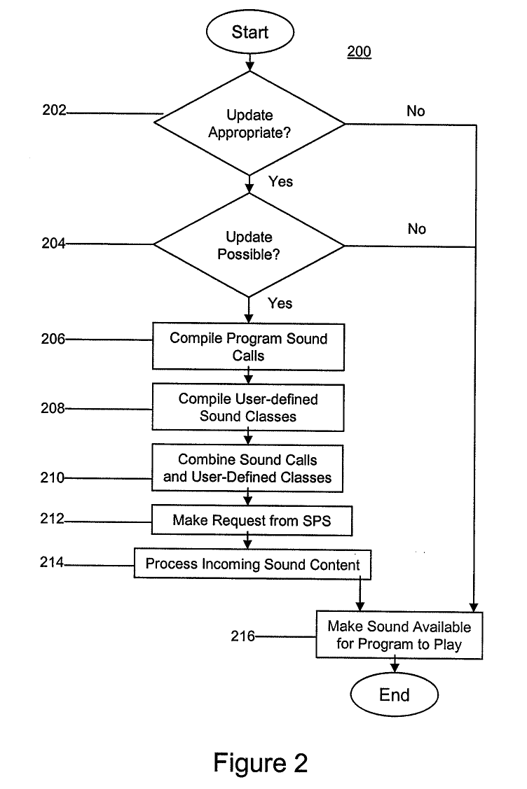

FIG. 2 represents an operational flow 200 of a system for dynamically serving sound content, wherein sound content is delivered to a user system 102a-n. For a discussion of how a user system utilizes such content, see FIG. 3 and the description thereof. Moreover, although the system is described in a certain order, here as in the rest of the description such an ordering is merely for demonstrative purposes and embodiments of the present invention may be implemented in an alternative order depending on the constraints of the particular embodiment.

The details of the presently described embodiment of the invention shall be herein described in terms of several more specific embodiments, although these are in no way a limitation on the scope of the present invention, but merely serve an illustrative purpose. In a first embodiment, the sound content is dynamically served into a computer program, with such computer program run on a personal computer, a dedicated video game console, or any similar device or combination thereof. In a second embodiment, the sound content is dynamically served into a motion picture or television program, with such motion picture being relayed to a viewing device from a playing device such as a standalone disk-based movie player, a cable provider set top box, or any similar device or combination thereof. In a third embodiment, the sound content is dynamically served into an advertisement broadcast by a regional broadcasting station, which enables the sound content of the advertisement to be varied for different regions without varying the video content of the advertisement.

At Block 202, the system determines if an update to the sound content of a product on a particular user system, such as the user system 102a, is appropriate. The appropriateness of an update to a particular user system can be based on several factors, including but not limited to the length of time since the previous update, a newfound availability to access external communications, a selection made by a user, or a change in the user-defined sound content pattern (as discussed in conjunction with Block 208).

By setting up a recurring update based on elapsed time, users or programmers can fine tune the length of use of a piece of sound content in a program to balance thorough exposure and enjoyment with freshness of content. Moreover, the requirement of further explicit actions by either user or programmer can be minimized via automated scheduling, and the system can deliver fresh content automatically.

If an update is appropriate, the system proceeds to Block 204. If an update is inappropriate, the system proceeds to Block 216. At Block 204, the system determines if an update of the sound content is possible for the user system. This determination hinges on details of the particular implementation, but such factors include but are not limited to: ability to access the network 110, a valid and currently paid subscription, having all required permissions, and the like.

The appropriateness of a sound content update can hinge on a paid subscription from the user to receive such updates, representing a sizeable potential for new revenue streams for content producers. In the first embodiment, for example, computer program users can subscribe to regular sound content updates from the computer program producers. Similarly, in the second embodiment, motion picture or television viewers can subscribe to regular sound content updates from the content providers associated with a particular product, or even a studio or similar grouping associated with a plurality of similar products. Also, in the third embodiment, regional advertising providers for an entity can subscribe to regularly updated sound content for any advertising pieces provided from a national advertising provider for their entity, allowing freshened and region-specific advertising sound content without requiring manual edits from each nationally supplied advertisement.

The system then determines what type of sound content a particular product requires. The system does this by combining at least two sets of parameters, including the choices of the designers (Block 206) and the choices of the user (Block 208), resulting in a unique combination of sound content influenced by the tastes of both the user and the content providers as well as by situations taking place (e.g., when a video game is played or a product is used, with those situations including: fast, slow, happy, angry, nervous, calm, sad, tired, scared, and aggressive). A combination of the two gives the system the ability to give the sound content the flexibility of a user-modifiable system while retaining the cohesiveness of a provider-created sound scheme.

At Block 206, the system compiles a list of sound content calls to fetch. In the first embodiment, these sound content calls are typically made within the code of the computer program. Such compilation can span all program code, code most likely to be called in the current user session, or just the next expected sound content call. Similarly, in the second and third embodiments, the sound content calls can be made within the context of each motion picture, television program, or advertisement in a manner known to a practitioner in the relevant art (e.g., embedding non-visual signals such as time codes in the product that can be interpreted by the player device). Such compilation could then span the entire product, a predefined range of calls surrounding the current viewing place of the user, the next expected sound call, or the like.

Such sound content calls will contain at least one level of abstractness to them, in that when a section of a product is meant to play a particular sound, the product calls a type of sound to be played. This allows programmers to maintain a level of control while still being flexible (e.g., allowing for different types of fast tempo music). For example, in the first embodiment, a computer program's code may call for the playing of a loud sound effect, a fast tempo piece of music, or a female voice calmly saying the word “Yes.” Similarly, in the second embodiment, a motion picture or television program may call for the playing of a slow and melodic piece of music during a panoramic sweep of the countryside, or a male voice reading a narrative voiceover. Likewise, in the third embodiment, an advertisement may call for a contemporary pop song from a local artist to play in the background while the user views dramatic footage. Note how, in each of these embodiments, the particular sound content played can be different for each user, so long as it matches the abstract calls. One skilled in the art could see how to implement such a level of abstract coding with well-known programming and data management techniques.

In an alternative embodiment of the present invention, Block 206 relays a standard set of sound content calls that covers all playable types of sound content. Such an alternate approach does not require the scanning of the product's specific sound content calls and thus has the benefit of simplicity.

At Block 208, the system determines a user configurable style filter for the type of sound content to be delivered. For example, a user selects from a menu labeled “Music” and changes a field labeled “Genre” from “Rock” to “Jazz”. Alternatively, the style setting could be configured in a location separate from individual products and could keep general settings across several similar products on the user system. In an aspect of the first embodiment, the style filter or setting could be user-configurable within the computer software itself or within a resident program tasked with keeping general settings across multiple computer programs. Example resident programs on home video game consoles tasked with keeping general settings across multiple games include: the Xross Media Bar on the PlayStation® 3, home menu on the PlayStation® Portable, the Dashboard on the XBOX 360™, the Home menu on the Wii™, and the Control Panel on the Windows® family of personal computer operating systems.

In the second embodiment, at Block 208, the style filter or setting could be user configurable within the motion picture player. For example, the style filter or setting could be user-configurable within the title menu of a specific DVD title. Alternatively, the motion picture player could have an overarching settings menu that would allow choices across multiple titles.

In the third embodiment, at Block 208, the style filter or setting could be user configurable within the television program or advertisement viewing. For example, the style filter or setting could be alterable in a device that automatically receives advertisements from a large-scale advertising office or agency and automatically converts them for the local market (e.g., having commercials with only local bands playing in the background, etc.).

At Block 210, the system combines parameters determined from Blocks 206 and 208 to determine what type of sound content should be gathered in the update. For example, if the required program sound content calls at Block 204 are for Fast Loud Music, Fast Soft Music, and Slow Soft Music, and the user-configured style setting as determined in Block 208 is “Jazz”, then Block 210 combines the two to effectively result in a list of “Fast Loud Jazz Music”, “Fast Soft Jazz Music”, and “Slow Soft Jazz Music.” Alternatively, if the style setting as determined in Block 208 is “Rock”, then Block 210 combines the two to effectively result in a list of “Fast Loud Rock Music”, “Fast Soft Rock Music”, and “Slow Soft Rock Music.”

At Block 212, the system transmits the combined sound content request pattern to the SPS 112 via the network 110. The system searches the SPS storage engine 116 and provides one or more multiple matching pieces of sound content back to the user system, like user system 102a, via the network 110. For a discussion of how sound content is stored in the SPS storage engine 116, please see FIG. 3.

Note that over time the sound content that is a successful match for the search in Block 212 can change on the service provider end. Thus, with no active input by the user, if an automated update is scheduled, the product receives fresh sound content without the user having to purchase a sound pack or make any other affirmative actions. This could enhance the value of a subscription-based model, allowing content providers an incentive to entice users into subscribing.

At Block 214, hardware (e.g., the processor 109) running the product processes the incoming sound content such that sound content will be accessible by the game. Such processing can take on multiple forms that one of ordinary skill in the art could implement. In an example embodiment of the present invention, the user system stores the sound content on a non-volatile storage medium for later playback. The non-volatile storage medium contains a plurality of sound content and, at Block 214, may or may not overwrite the preexisting sound content, depending on the limitations and concerns of the particular implementation. This embodiment has among its benefits the ability to schedule such deliveries at times other than when the user is enjoying the product, allowing for optimization of network usage and hardware processing power. Moreover, larger file sizes that supersede the ability of the network to download in real time can be utilized, allowing greater flexibility for sound content file size, communications hardware, and the like.

In an alternative embodiment, at Block 214 the sound content is streamed in real-time from the network 110 through to the product in a manner known to a person skilled in the art. Such sound content could then be stored in volatile memory only, in a sort of buffering pattern, to be utilized by the game immediately, for example.

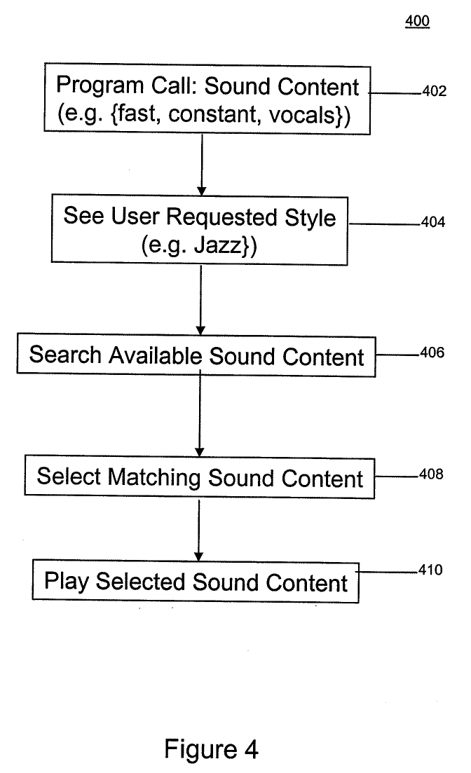

At Block 216, the system makes the sound content available for the product. In an aspect of the embodiment, additional sound content may be downloaded asynchronously with the user utilizing the product, and a reference to the recently downloaded specific sound content is passed to the product. If no update has taken place, the default sound content would be made available to the product. Please see FIG. 4 for further discussion on how the product determines what sound content to utilize.

FIG. 3 represents an operational flow 300 of an example embodiment of the invention, wherein sound content is introduced into the system 100 and originally classified in the SPS 112. This process 300 can introduce new or rare sound content to the user, thus increasing the variety of sound content experienced by the user. Note that this is just one example embodiment, and other embodiments of the invention, perhaps involving a different ordering of the processes described herein, are acceptable.

At Block 302, the sound content is physically introduced into the system 100 through the SPS user interface engine 118. This can take on multiple forms known to persons skilled in the art, including but not limited to an analog signal introduced via physical sound cable, an electronic data transfer of a digitized signal, the introduction of a compact disc containing the sound content, a microphone recording the sound content, a synchronization with a personal handheld device, etc. Moreover, this process can be automated, such that, for example, music is automatically introduced into the system through a network connection by an automated process on a remote server.

At Block 304, the sound content is analyzed. In an aspect of the embodiment, this analysis takes place through the SPS user interface engine 118 via a human listener who can subjectively categorize a particular piece of sound content. For example, an operator could hear a particular piece of sound content and classify it as “rock”, “fast tempo”, and “female vocals”. In another aspect of the embodiment, this analysis takes place via an automated process performed by the processor 120 of the system 100. The processor 120 analyzes the signal pattern to determine characteristics about the sound content, such as length, volume, tempo, etc. Such an automated process could be implemented by one of ordinary skill in the art using known technologies. Another aspect of the embodiment combines both manual and automated classification, both of which are described above.

At Block 306, the sound content is assigned a unique identifier. The assignment is set up such that the system 100 calls up a particular unique identifier, the system 100 would access precisely that sound content and no others.

At Block 308, the classifications of the sound recording as determined in Block 304 are associated with the unique identifier established at Block 306. The result is then stored in a searchable format, such that a search for a particular classification would yield a plurality of unique identifiers for all sound content that fits the desired classification. There are multiple ways to accomplish this, using known data organization and retrieval techniques, such as a commercial database, a database, a data lookup table, or the like.

FIG. 4 represents an operational flow 400 of an example embodiment of the present invention, wherein the system 100 chooses a particular piece of sound content to be delivered to a user system from the SPS 112.

At Block 402, during the course of running the product, the product makes a call for sound content. Such a call is represented by at least one level of abstraction, as described in the discussion surrounding Block 206. At Block 404, the system consults a user-alterable style setting for a class of sound content, as described in the discussion surrounding Block 208.

At Block 406, the system searches for sound content on the storage engine 104 that is made available to the product (see FIG. 2) that matches the combined variables gathered at Blocks 402 and 404. Such a search can be conducted using methods and algorithms known to those of ordinary skill in the art.

At Block 408, the system selects a piece of sound content from the search result returned at Block 406. If multiple results are returned, the system can use any number of criteria to narrow down the results and return a single result. Such criteria may include most recent, most popular, easiest to play, from a favored content provider, from a particular brand for promotion of that brand, etc.

At Block 410, the sound content selected at Block 408 is actually played through the associated hardware such that the user hears the sound content as part of the product use experience.

Aspects of the present invention (e.g., the sound content delivery system 100, or any part(s) or function(s) thereof) may be implemented using hardware, software or a combination thereof and may be implemented in one or more computer systems or other processing systems. However, the manipulations performed by the present invention were often referred to in terms, such as classifying or sorting, which are commonly associated with mental operations performed by a human operator. No such capability of a human operator is necessary, or desirable in many cases, in any of the operations described herein that form part of the present invention. Rather, the operations are machine operations. Useful machines for performing the operation of the present invention include general-purpose digital computers or similar devices.

In fact, in one embodiment, the invention is directed toward one or more computer systems capable of carrying out the functionality described herein. An example of a computer system 500 is shown in FIG. 5.

The computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

The computer system 500 can include a display interface 502 that forwards graphics, text, and other data from the communication infrastructure 506 (or from a frame buffer not shown) for display on the display unit 530.

The computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well-known manner. The removable storage unit 518 represents a floppy disk, magnetic tape, optical disk, etc. which is read by and written to by the removable storage drive 514. As will be appreciated, the removable storage unit 518 includes a computer usable storage medium having stored therein computer software and/or data.

In alternative embodiments, secondary memory 510 may include other similar devices for allowing computer programs or other instructions to be loaded into the computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, a USB memory stick, a SD memory card, and other removable storage units 522 and interfaces 520, which allow software and data to be transferred from the removable storage unit 522 to computer system 500.

The computer system 500 may also include a communications interface 524. The communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via the communications interface 524 are in the form of signals 528 which may be electronic, electromagnetic, optical or other signals capable of being received by the communications interface 524. These signals 528 are provided to the communications interface 524 via a communications path (e.g., channel) 526. This channel 526 carries signals 528 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 514 and/or a hard disk installed in hard disk drive 512. These computer program products provide software to computer system 500. The invention is directed to such computer program products.

Computer programs (also referred to as computer control logic) are stored in the main memory 508 and/or the secondary memory 510. Computer programs may also be received via the communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into the computer system 500 using the removable storage drive 514, the hard drive 512 or the communications interface 524. The control logic (software), when executed by the processor 504, causes the processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the figures, which highlight the functionality and advantages of the present invention, are presented for example purposes only. The architecture of the present invention is sufficiently flexible and configurable, such that it may be utilized (and navigated) in ways other than that shown in the accompanying figures.

What is claimed is:

1. A computerized or automated method for altering sound content of an audiovisual product, comprising:
identifying, by a server system, a current sound content of an audiovisual product residing in a user system, the current sound content being identified based on information from the audiovisual product, the information including a type of the current sound content;
determining, by the server system, whether the current sound content is to be altered;
obtaining, by the server system, an altered sound content based on a combination of the type of the current sound content included in the information and a user preference; and
providing, by the server system, the altered sound content to the user system, if it is determined that the current sound content is to be altered.

2. The method of claim 1, wherein the server system determines that the current sound content is to be altered based on a date associated with the current sound content, on a date associated with the audiovisual product, on the type of the current sound content, or on the type of the audiovisual product.

3. The method of claim 1, further comprising:
receiving, by the server system, the user preference for sound content from the user system,
wherein the server system determines whether the current sound content is to be altered based on a comparison of the current sound content and the user preference for sound content.

4. The method of claim 1, further comprising:
accessing, by the server system, subscription information stored in a memory,
wherein the server system provides the altered sound content to the user system if the user system is listed in the subscription information accessed from the memory.

5. The method of claim 1, further comprising:
accessing, the server system, a memory storing sound content to obtain the altered sound content.

6. The method of claim 1, wherein the server system provides the altered sound content in real time during execution of the audiovisual product.

7. The method of claim 1, wherein the audiovisual product comprises a computer program, a video game, software, a motion picture, a television program, a commercial, or any combination thereof.

8. The method of claim 7, wherein the altered sound content provided to the user system includes sound units that correspond to one or more situations taking place when the audiovisual product is viewed, the one or more situations being identified in the type of the current sound content in the information.

9. The method of claim 8, wherein the situations taking place are identified as an emotion.

10. The method of claim 8, wherein the situations taking place include fast, slow, happy, angry, nervous, calm, sad, tired, scared, aggressive, or any combination thereof.

11. The method of claim 1, wherein the altered sound content is characterized by a genre.

12. The method of claim 11, wherein the genre comprises jazz, hip-hop, classic rock, hard rock, punk, folk, blues, funk, classical, opera, x-rated, child-friendly, or any combination thereof.

13. A system for altering sound content of an audiovisual product residing in a user system connected to a network, the system comprising a processor and programmed with modules to:
identify a current sound content of an audiovisual product residing in a user system, the current sound content being identified based on information from the audiovisual product, the information including a type of the current sound content;
determine whether the current sound content is to be altered;
obtain an altered sound content based on a combination of the type of the current sound content received in the information and a user preference; and
provide the altered sound content to the user system, if it is determined that the current sound content is to be altered.

14. The system of claim 13, wherein the system determines that the current sound content is to be altered based on a date associated with the current sound content, on a date associated with the audiovisual product, on the type of the current sound content, or on the type of the audiovisual product.

15. The system of claim 13,
wherein the processor is further programmed with a module to receive, from the user system, a user preference for sound content, and
wherein the system determines whether the current sound content is to be altered based on a comparison of the current sound content and the user preference for sound content.

16. The system of claim 13,
wherein the processor is further programmed with a module to access subscription information stored in a memory, and
wherein the system provides the altered sound content to the user system if the user system is listed in the subscription information accessed from the memory.

17. The system of claim 13, wherein the processor is further programmed with a module to access a memory storing sound content to obtain the altered sound content.

18. The system of claim 13, wherein the altered sound content is provided in real time during execution of the audiovisual product.

19. The system of claim 13, wherein the audiovisual product comprises a computer program, a video game, software, a motion picture, a television program, a commercial, or any combination thereof.

20. The system of claim 19, wherein the altered sound content provided to the user system includes sound units that correspond to situations taking place when the audiovisual product is viewed, the one or more situations being identified in the type of the current sound content in the information.

21. The system of claim 20, wherein the situations taking place are identified as an emotion.

22. The system of claim 20, wherein the situations taking place include fast, slow, happy, angry, nervous, calm, sad, tired, scared, aggressive, or any combination thereof.

23. The system of claim 1, wherein the altered sound content is characterized by a genre.

24. The system of claim 23, wherein the genre comprises jazz, hip-hop, classic rock, hard rock, punk, folk, blues, funk, classical, opera, x-rated, child-friendly, or any combination thereof.

25. A computer-readable storage medium storing a program that when executed by a computer causes the computer to implement a method of altering sound content of a user computer program, wherein the method comprises:
identifying a current sound content of an audiovisual product residing in a user system, the current sound content being identified based on information from the audiovisual product, the information including a type of the current sound content;
determining whether the current sound content is to be altered;
obtaining an altered sound content based on a combination of the type of the current sound content received in the information and a user preference; and
providing the altered sound content to the user system, if it is determined that the current sound content is to be altered.
